(19) United States
(12) Patent Application Publication
(10) Pub. No.: US 2001/0052126 A1
(43) Pub. Date: Dec. 13, 2001

(54) INFORMATION RECEIVING AND REPRODUCING APPARATUS AND INFORMATION RECORDING MEDIUM

(76) Inventors: MASARU NANKI, YOKOHAMA-SHI (JP); TOSHINORI MURATA, YOKOHAMA-SHI (JP); KENJI KATSUMATA, YOKOHAMA-SHI (JP); SIGERU YONEDA, YOKOHAMA-SHI (JP); TAKUYA MATSUMOTO, YOKOHAMA-SHI (JP)

Correspondence Address: FAY SHARPE BEALL FAGAN, MINNICH & MCKEE, 104 EAST HUME AVENUE, ALEXANDRIA, VA, 22301

(21) Appl. No.: 09/075,962

(22) Filed: May 11, 1998

(30) Foreign Application Priority Data
May 16, 1997 (JP) 09-126743

(51) Int. Cl. G06F 3/00; G06F 13/00

(52) U.S. Cl. 725/55

(57) ABSTRACT

In an apparatus for receiving a digital broadcasting, the apparatus become easier for a user to handle by supplying a recording medium in which service information containing information that cannot be obtained in the broadcasting are recorded to the user. An information receiving and reproducing apparatus comprises a detachable recording medium in which digital broadcasting service information are recorded, a reproducing control apparatus for selectively reproducing service information from the recording medium, means for generating an OSD (on-screen display) signal based on a reproduced signal, a decoding unit for decoding an encoded reproduced signal or an encoded received signal and an OSD synthesizing unit for synthesizing the OSD signal and a decoded video signal.

### BACKGROUND OF THE INVENTION

The present invention relates to a digital broadcasting/communication reception and recording medium reproducing apparatus, and particularly relates to an information receiving and reproducing apparatus for analyzing service information from a broadcasting and a recording medium and controlling apparatus in accordance with analyzed service information and an information recording medium for use with the information receiving and reproducing apparatus.

JP-A-8-56350 describes a technology of a digital broadcasting reception system for selecting a desired program by receiving a digital signal in which a plurality of information are multiplexed and transmitted. In this conventional technology, there is described the digital broadcasting reception system in which a plurality of service information are added with identification data and thereby arranged in a specific format, program specification data indicating a corresponding relationship between the service information and the packet identification data also is arranged in a specific format by a packet and each program is searched from a multiplexed signal in which these packets are multiplexed and transmitted.

FIG. 1 of the accompanying drawings is a functional block diagram showing a digital broadcasting reception apparatus according to the prior art.

As shown in FIG. 1, in a digital broadcasting reception apparatus 150, a modulated signal in which a plurality of multiplexed video and audio signals and/or data are modulated is inputted to an input terminal 101. The input modulated signal is supplied from the input terminal 101 to a reception unit 11, in which it is demodulated into an original multiplexed bit stream and then error-corrected. A demultiplexer unit 12 selects and extracts one desired encoded digital signal from the multiplexed bit stream under control of an analysis control unit 14. The encoded digital signal from the demultiplexer unit 12 is supplied to a decoding unit 15, in which it is decoded into an original digital video/audio signal.

The analysis control unit 14 includes a program guide display processing unit 141 for controlling a program guide display processing, a program reserve processing unit 142 for controlling a program reserve processing and a program detail display processing unit 143 for controlling a program detail display processing. The analysis control unit 14 analyzes received information, controls the respective units and generates OSD (on-screen display) data.

The program guide display processing unit 141 controls the demultiplexer unit 12 in order to obtain desired information. Service information thus obtained by this control is stored in a memory unit 13.

The program guide display processing unit 141 generates OSD data of program guide based on the service information stored in the memory unit 13.

An OSD synthesizing unit 16 synthesizes the OSD data from the analysis control unit 14 and the video signal decoded by the decoding unit 15 to provide digital synthesized video data. The digital video data from the OSD synthesizing unit 16 is supplied to a D/A (digital-to-analog) converter 19, in which it is converted into an analog video signal. This analog video signal is outputted to an output terminal 102. In this fashion, a program guide is displayed on a display apparatus (not shown).

To reserve a program, a user selects a desired program on a program guide, for example, displayed on a screen of a display apparatus. The program reserve processing unit 142 controls the demultiplexer unit 12 to extract information necessary for reserving a selected program, and stores the information thus extracted in the memory unit 13.

The program reserve processing unit 142 controls the reception unit 11, the demultiplexer unit 12 and the decoding unit 15 in accordance with the program reserve information stored in the memory unit 13 in such a manner that a reserved program may be received at a broadcasting start time of the reserved program.

In this fashion, the reserved program may be received at the broadcasting time of the reserved program and displayed on the screen of the display apparatus.

When program detail information is displayed, the program detail display processing unit 143 generates program detail text OSD data from program detail text data contained in the received service information.

The OSD synthesizing unit 16 synthesizes the OSD data from the analysis control unit 14 and the video signal decoded by the decoding unit 15 to provide digital synthesized video data. The digital video data from the OSD synthesizing unit 16 is outputted to the output terminal 102. In this fashion, program detail information is displayed on a display apparatus (not shown).

When a program guide is displayed on the screen of the display apparatus by the prior-art digital broadcasting reception apparatus, received service information is temporarily stored in the memory 13, and a program guide is created by retrieving information such as a program title or a broadcasting time necessary for a program from the service information. In most cases, service information transmitted by the broadcasting generally covers a program guide of about one week. Hence, the user cannot obtain service information covering one week or longer on the screen of the display apparatus. Therefore, the program reserve may cope with only a program within one week.

Further, in the digital broadcasting, there is transmitted program detail text data in order to explain contents of a program. The user is able to learn the contents of program before a broadcasting start time of a desired program by reading a program detail text. However, it is frequently observed that, depending upon the contents of program, the user becomes unable to understand the contents of program only by reading the program detail text.

### SUMMARY OF THE INVENTION

In view of the aforesaid aspect, it is an object of the present invention to provide an information receiving and reproducing apparatus using a recording medium in which there are recorded service information whose amount of information is larger than that of service information transmitted via a digital broadcasting in a digital broadcasting reception apparatus.

It is another object of the present invention to provide an information receiving and reproducing apparatus capable of displaying moving picture information indicative of contents of program as service information except a program detail text.

The present invention may be achieved by reception means for receiving and demodulating a modulated broadcasting/communication signal in which video/audio data are encoded/multiplexed, demultiplexer means for demultiplexing a first desired signal from the signal demodulated by the reception means, reproducing means for reproducing a signal from a detachable recording medium and outputting a reproduced signal as a second signal, signal selection means for selecting and outputting the first signal demultiplexed by the demultiplexer means and the second signal reproduced by the reproducing means, decoding means for decoding the first or second signal selected by the signal selection means, OSD (on-screen display) synthesizing means for synthesizing a signal decoded by the decoding means with an OSD signal and an analyzing control means for analyzing the first control signal demultiplexed by the demultiplexer means and the second control signal reproduced by the reproducing means and controlling the signal selection means and the OSD synthesizing means.

According to the present invention, a DVD (Digital Versatile Disc) is used as a recording medium, service information containing program moving picture information composed of promotion video/audio data of respective programs of broadcasting of one month, for example, are recorded on the recording medium and information recorded on the recording medium is reproduced, analyzed and displayed on a display apparatus, whereby a user is able to obtain information, which cannot be obtained only by received service information, on the display apparatus. Furthermore, since there are obtained service information of one month, for example, it becomes possible for the user to reserve programs of one month or shorter. Hence, the user may use an information receiving and reproducing apparatus and an information recording medium more conveniently.

### BRIEF DESCRIPTION OF THE DRAWINGS

FIG. 1 is a functional block diagram showing an example of a digital broadcasting reception apparatus according to the prior art;

FIG. 2 is a block diagram showing an information receiving and reproducing apparatus according to an embodiment of the present invention;

FIG. 3 is a diagram showing a format of information recorded on a recording medium according to the present invention;

FIG. 4 is a flowchart to which reference will be made in explaining an operation of the information receiving and reproducing apparatus according to the embodiment shown in FIG. 2;

FIG. 5 is a diagram showing the manner in which a program guide is displayed according to the present invention; and

FIG. 6 is a diagram showing an information receiving and reproducing apparatus according to another embodiment of the present invention.

### DESCRIPTION OF THE PREFERRED EMBODIMENTS

An information receiving and reproducing apparatus according to the present invention will hereinafter be described with reference to the drawings.

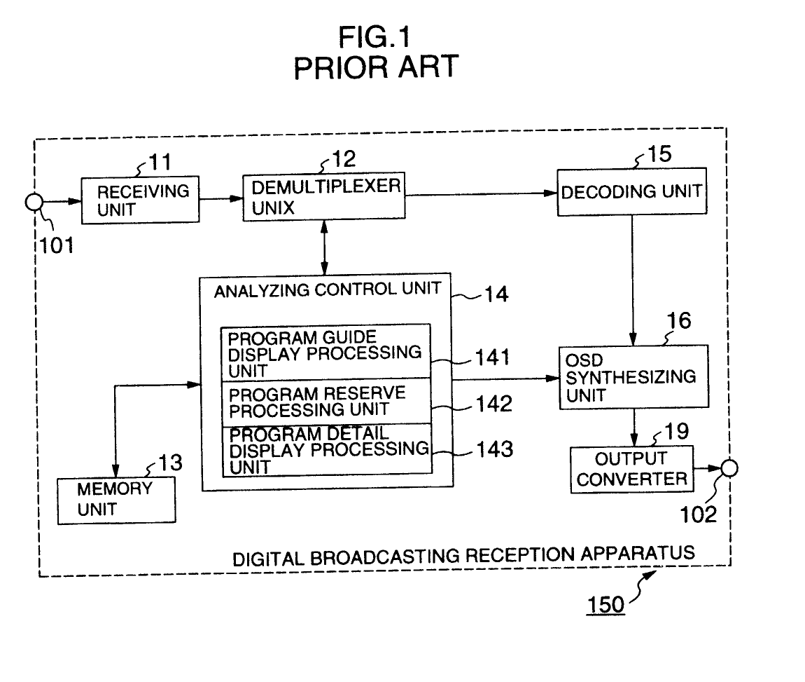

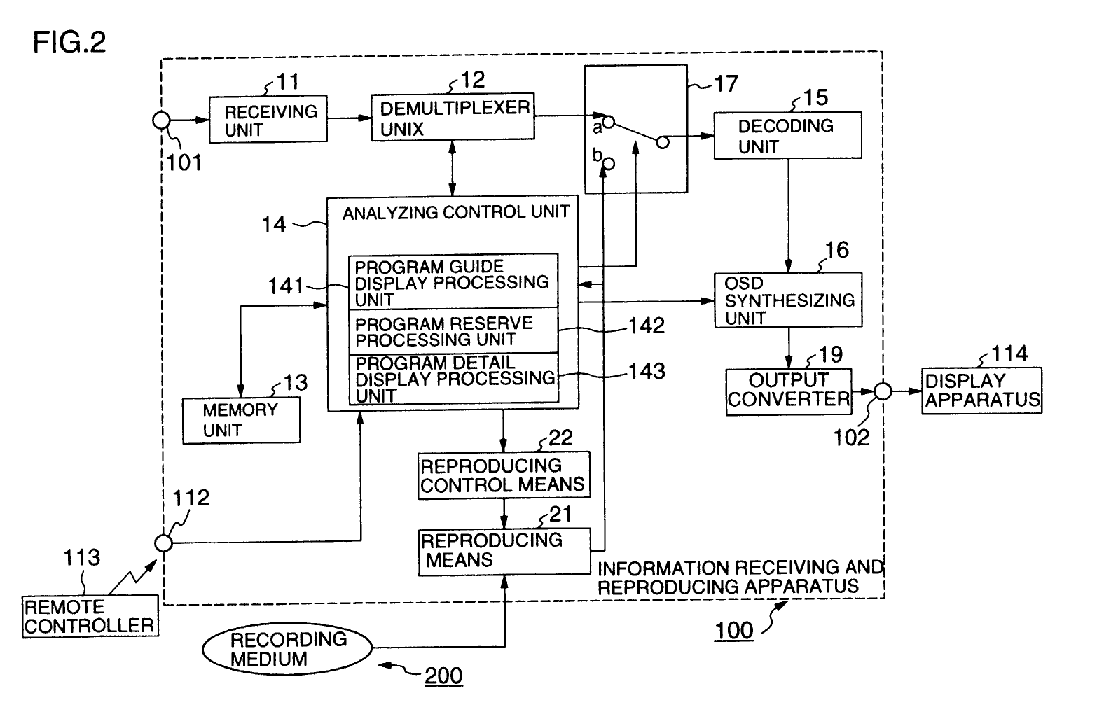

FIG. 2 is a block diagram showing an information receiving and reproducing apparatus according to a first embodiment of the present invention. In FIG. 2, elements and parts identical to those of FIG. 1 are marked with the same reference numerals.

As shown in FIG. 2, an information receiving and reproducing apparatus generally depicted by reference numeral 100 comprises the input terminal 101 to which a modulated signal in which several video/audio/data are encoded and multiplexed is inputted, the reception unit 11, the demultiplexer unit 12, the analyzing control unit 14, the memory unit 13, the decoding unit 15, the OSD synthesizing unit 16, the output converter 19 for converting the output signal from the OSD synthesizing unit 16 into a signal suitable for display, the output terminal 102 from which the signal from the output converter 19 is outputted, the signal selection means 17, the reproducing means 21 and the reproducing control unit 22. Service information recorded on a recording medium 200 is reproduced by the reproducing means 21.

The analyzing control unit 14 includes the program guide display unit 141 for controlling a program guide display processing, the program reserve processing unit 142 for controlling a program reserve processing and the program detail display processing unit 143 for controlling a program detail display processing. The analyzing control unit 14 controls respective units by analyzing received or reproduced information, and generates OSD data.

The reception unit 11 demodulates the received signal from the input terminal 101 to provide an original multiplexed bit stream signal, and also corrects an error occurred during the transmission.

The demultiplexer unit 12 selects and extracts a desired video/audio and/or data signal from the multiplexed bit stream signal. The bit stream signal is generally an encoded digital signal string in which a plurality of service information containing video and audio data are multiplexed along a time-base direction and arranged in a specific packet form.

When a user operates a remote controller 113, a remote control command signal from the remote controller 113 is received at a remote control reception unit 112. The analyzing control signal 14 identifies a necessary packet signal string based on the remote control command signal supplied thereto through the remote control reception unit 112, and instructs packet ID to the demultiplexer unit 12. As a consequence, the demultiplexer unit 12 selects only a packet of necessary channel based on a packet identification signal PID attached to the start of each packet, and transmits the selected packet to the signal selection means 17. If the designated packet ID is service information, then a packet of selected service information is stored in the memory unit 13 as service information.

The recording medium 200 is a medium such as a DVD in which there are previously recorded broadcasting service information. The recording medium 200 is detachable from the reproducing means 21.

The reproducing means 21 reproduces information from the recording medium 200 under control of the reproducing control unit 22.

The signal selection means 17 selects one of two signals supplied thereto from the demultiplexer unit 12 and the reproducing means 21.

The decoding unit 15 decodes the encoded signal supplied thereto from the signal selection means 17.

The OSD synthesizing unit 16 synthesizes the OSD data and the decoded video signal. Incidentally, OSD data such as program guide may be either displayed together with a received picture or displayed solely.

The analyzing control unit 14 includes a CPU (central processing unit) which is operable based on a program recorded on a memory. While the remote controller 113 is used in the embodiment shown in FIG. 2, the present invention is not limited thereto, and an input device such as a mouse or keyboard may be used.

An operation of the information receiving and reproducing apparatus 100 according to this embodiment will be described below.

Initially, the manner in which a digital broadcasting is received and a program guide is displayed on a display apparatus by using received service information will be described.

When a program guide is displayed on the display apparatus, a digital signal in which a plurality of information are multiplexed is inputted to the input terminal 101, and then digital signal is demodulated by the reception unit 11.

The program guide display processing unit 141 controls the signal selection means 17 in such a manner as to select a signal a from the demultiplexer unit 12. Also, the program guide display processing unit 141 controls the demultiplexer unit 12 in order to obtain desired information. The service information thus obtained in the analyzing control unit 14 is stored in the memory unit 13.

The decoding unit 15 decodes signals successively outputted from the demultiplexer unit 12.

The program guide display processing unit 141 generates program guide OSD data based on the service information stored in the memory unit 13.

The OSD synthesizing unit 16 synthesizes the OSD data from the analyzing control unit 14 and the video signal decoded by the decoding unit 15. The synthesized digital data from the OSD synthesizing unit 16 is converted into an analog signal by the output converter 19, and outputted to the output terminal 102. In this fashion, the program guide is displayed on a screen of a display apparatus 114.

When a program is reserved, a user selects a desired program on a program guide picture displayed on the screen of the display apparatus 114. The program reserve processing unit 142 controls the demultiplexer unit 12 to extract information necessary for the selected program such as a program broadcasting start time or a transponder number, and stores the extracted information in the memory unit 13. The program reserve processing unit 142 controls the reception unit 11, the demultiplexer unit 12, the signal selection means 17 and the decoding unit 15 in such a manner that a reserved program can be received at the broadcasting start time of the reserved program in accordance with the program reserve information stored in the memory unit 13. Specifically, the reception unit 11 is controlled in the setting of a frequency of a transponder in order to select desired one transponder from a plurality of transponders through which bit stream data are transmitted. The demultiplexer unit 12 is controlled in such a manner that a reserve channel identification signal PID is set and only the packet thereof is selected. The signal selection means 17 is controlled in such a way as to select an input terminal a in order to reproduce a signal which is received at present. The decoding unit 15 is controlled such that it expands compressed video and audio signals to provide original video and audio signals.

In this manner, the reserved program may be received at the broadcasting time of the reserved program and displayed on the screen of the display apparatus 114.

When program detail information is displayed, the program detail display processing unit 143 controls the demultiplexer unit 12 such that program detail information is extracted from received service information and stored in the memory unit 13. The program detail display processing unit 143 generates program detail text OSD data based on the program detail information stored in the memory unit 13.

The OSD synthesizing unit 16 synthesizes the OSD data from the analyzing control unit 14 and the video signal decoded by the decoding unit 15. The thus synthesized digital data is converted by the output converter 19 and then outputted to the output terminal 102.

In this fashion, program detail information is displayed on the screen of the display apparatus 114.

The manner in which a program is displayed by using information recorded on the recording medium 200 will be described next.

The recording medium 200 is a DVD, for example, sent from a broadcasting enterprise to each user periodically, e.g. once per month. In this recording medium 200, there are recorded service information of a corresponding period (one month). Initially, information recorded on the recording medium 200 will be described.

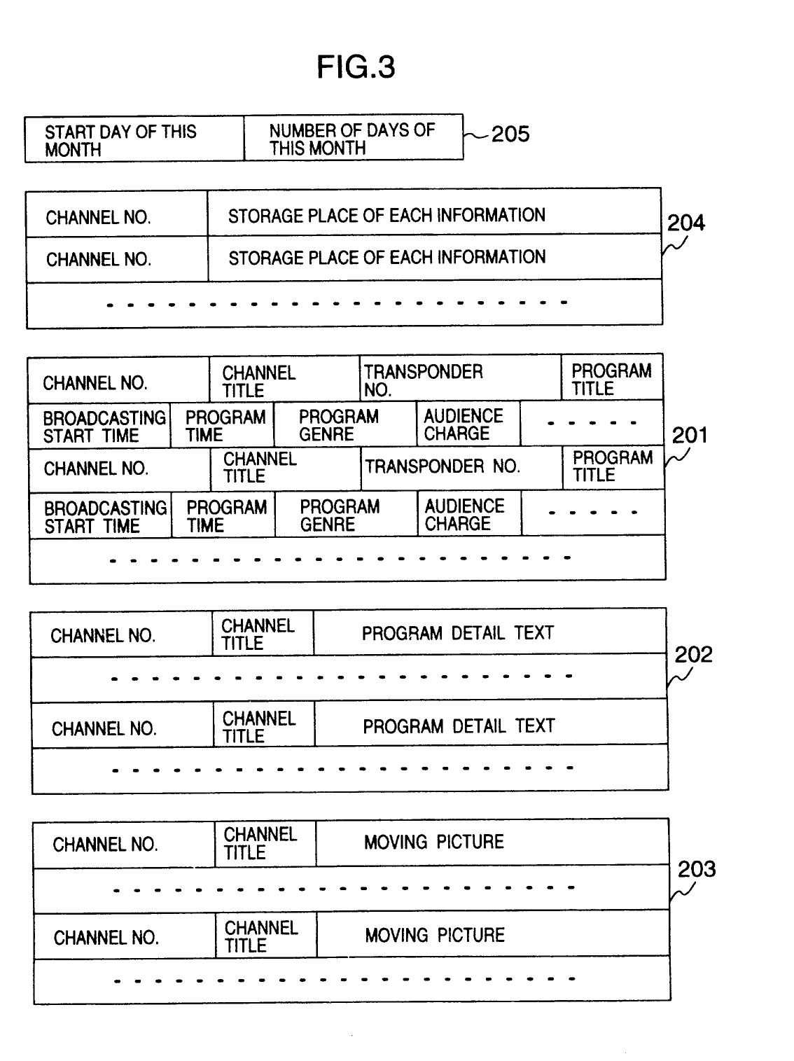

FIG. 3 shows an example of service information recorded on the recording medium 200. As shown in FIG. 3, service information recorded on the recording medium 200 comprises program guide information 201 indicating attribute information of at least each program, program detail information 202 indicating contents of program, program moving picture information 203 for the promotion of each program, program relation information 204 for relating the program guide information 201 to the program moving picture information 203 and calendar information 205.

In the program guide information 201, information such as channel title, transponder number, program title of each program, broadcasting time, program genre or audience charge are arranged from top to bottom in the sequential order of channel numbers, and are also arranged from left to right in the sequential order of time.

In the program detail information 202, information such as program detail text of each program are arranged in the sequential order similar to that of the program guide information 201.

In the program moving picture information 203, promotion video/audio data of each program, for example, are encoded as moving picture data by an MPEG2 (Moving Picture Experts Group 2) system and arranged in the sequential order similar to that of the program guide information 201.

The program relation information 204 relates each information by indicating places where the program guide information 201, the program detail information 202 and the program moving picture information 203 of each channel are stored.

The calendar information 205 is date information of the corresponding month.

The program guide information 201 to the program relating information 204 are generated at every date of the calendar information 205.

While the program guide display processing unit 141, the program reserve processing unit 142 and the program detail display processing unit 143 are independently illustrated in FIG. 2, there is programmed such that the CPU in the analyzing control unit 14 can execute all operations of these processing units 141, 142 and 143. The user sends a command signal to the analyzing control unit 14 by operating the remote controller 113 in such a manner that desired data may be displayed on the screen of the display apparatus 114.

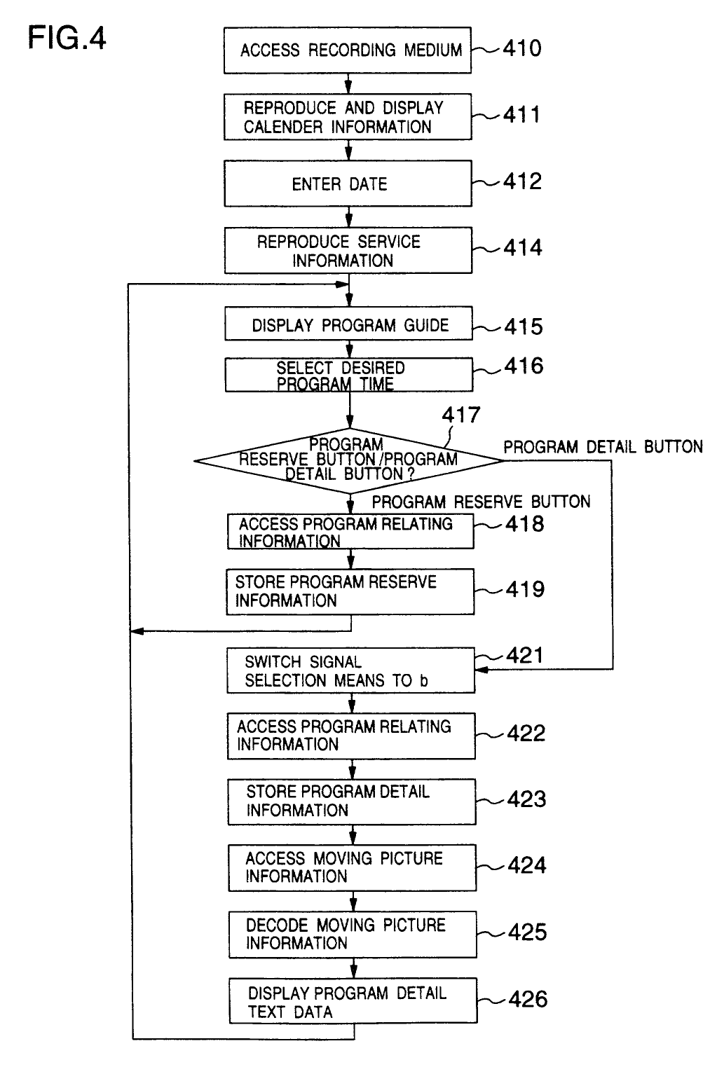

The manner in which a program is displayed by using the recording medium 200 will be described with reference to FIGS. 2 to 4.

Initially, when a user instructs a display of calendar by operating the remote controller 113, the analyzing control unit 14 accesses the recording medium 200 (step 410), and controls the reproducing control unit 22 in such a way as to reproduce the calendar information 205 recorded on the recording medium 200 (step 411). The reproducing control unit 22 controls the reproducing means 21 to reproduce the calendar information 205 from the recording medium 200. The analyzing control unit 14 generates calendar picture OSD data based on the calendar information 205 thus reproduced. The OSD synthesizing unit 16 synthesizes the calendar picture OSD data from the analyzing control unit 14 and the video signal decoded by the decoding unit 15. The thus synthesized digital data is converted by the output converter 19 and then outputted to the output terminal 102. In this manner, a calendar picture is displayed on the screen of the display apparatus 114.

When the user selects a desired date on the calendar picture by operating cursor keys on the remote controller 113 (step 412), the analyzing control unit 14 controls the reproducing control unit 22 in such a manner as to reproduce the program relating information 204 (step 414). Under control of the reproducing control unit 22, the reproducing means 21 reproduces the program relating information 204. The program guide display processing unit 141 controls the reproducing control unit 22 such that the program guide information 201 of the selected date is reproduced in accordance with the reproduced program relating information 204. The reproducing control unit 22 controls the reproducing means 21 such that the reproducing means 21 reproduces the program guide information 201. The program guide display processing unit 141 stores the reproduced program guide information 201 in the memory unit 13. The program guide display processing unit 141 generates program guide picture OSD data based on the program guide information stored in the memory unit 13 (step 415). The OSD synthesizing unit 16 synthesizes the program guide picture OSD data of the selected date and the video signal decoded by the decoding unit 15. The thus synthesized digital data from the OSD synthesizing unit 16 is converted by the output converter 19 and then outputted to the output terminal 102.

In this manner, the program guide of the selected date is displayed on the screen of the display apparatus 114.

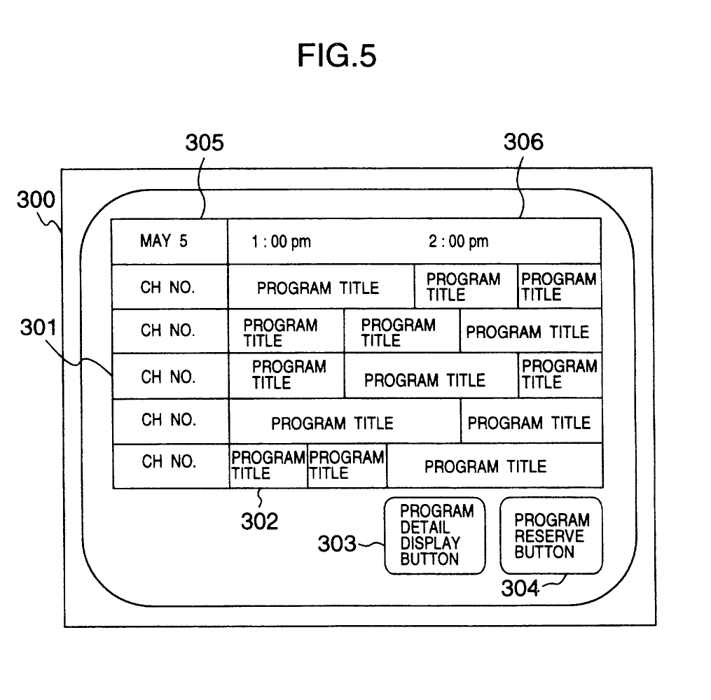

FIG. 5 shows an example of a program guide displayed on a screen 300 of the display apparatus 114. As shown in FIG. 5, a program guide displayed on the screen 300 of the display apparatus 114 comprises a channel NO. column 301 of program guide, a program title column 302 of program guide, a date column 305 of program guide and a broadcasting time column 306 of program guide. Further, on the screen 300 of the display apparatus 114, there are displayed a program detail display button 303 and a program reserve button 304.

The manner in which a program is reserved will be described below. Under the condition that the program guide shown in FIG. 5 is displayed, the user selects the desired program title 302 by operating the cursor keys on the remote controller 113 (step 416), and then selects the program reserve button 304. The program reserve processing unit 142 controls the reproducing control unit 22 in such a manner as to reproduce the program relating information 204 recorded on the recording medium 200 (step 418). Under control of the reproducing control unit 22, the reproducing means 21 reproduces the program relating information from the recording medium 200. The program reserve processing unit 142 controls the reproducing control unit 22 in such a manner that the program guide information 201 in which information of the selected program is reproduced in accordance with the reproduced program relating information 204. The reproducing control unit 22 controls the reproducing means 21 such that the reproducing means 21 may reproduce the program guide information 201.

The program reserve processing unit 142 extracts information necessary for reserving the selected program, such as a program broadcasting start time or a transponder No. from the reproduced program guide information 201, and stores the thus extracted information in the memory unit 13 (step 419).

The program reserve processing unit 142 controls the receiving unit 11, the demultiplexer unit 12, the signal selecting means 17 and the decoding unit 15 in such a manner that the reserved program may be received at the reserved program broadcasting start time in accordance with the program reserve information stored in the memory unit 13.

In this manner, the reserved program may be received at the reserved program broadcasting time and displayed on the display apparatus 114.

The manner in which program detail information is displayed will be described. Under the condition that the program guide shown in FIG. 5 is displayed on the screen 300 of the display apparatus 114 (step 415), the user selects a desired program title 302 (step 416), and selects the program detail display button 303 (step 417). The program detail display processing unit 143 controls the signal selecting means 17 in such a manner that the signal selecting means 17 may select an input terminal b (step 421). Also, the program detail display processing unit 143 controls the reproducing control unit 22 in such a manner as to reproduce the program relating information 204 (step 422). The reproducing control unit 22 controls the reproducing means 21 such that the reproducing means 21 may reproduce the program relating information 204. The program detail display processing unit 143 controls the reproducing control unit 22 in such a manner that the program detail information 202 of the selected program and the program moving picture information 203 are reproduced in accordance with the reproduced program relating information 204 (steps 422 and 424). The reproducing control unit 22 controls the reproducing means 21 in such a manner as to reproduce the program detail information 202 and the program moving picture information 203. The program detail display processing unit 143 stores the reproduced program detail information 202 in the memory unit 13 (step 423).

Since the program relating information 204 shown in FIG. 3 indicates the address in which each information is stored, the analyzing control unit 14 transfers the program detail information 202 to the memory unit 13 and also transfers the program moving picture information 203 through the selecting means 17 to the decoding unit 15 based on the address information.

Accordingly, when the program moving picture information is reproduced, the analyzing control unit 14 controls the decoding unit 15 in such a manner that the decoding unit 15 may decode the moving picture information (step 425). As a result, the decoding unit 15 decodes moving picture data from the reproduced program moving picture information 203.

The program detail display processing unit 143 generates the program detail text OSD data based on the program detail information 202 stored in the memory unit 13 (step 426). The OSD synthesizing unit 16 synthesizes the moving picture data decoded by the decoding unit 15 and the program detail text OSD data. The thus synthesized digital data is supplied to the output converter 19, in which it is converted into an analog signal and then outputted to the output terminal 102. In this manner, a program detail picture containing the moving picture of the selected program is displayed on the screen 300 of the display apparatus 114.

Incidentally, moving picture information generally has a reproducing time of about 1 to 2 minutes, and the user may freely make programming such that the moving picture information may be reproduced repeatedly or original program guide may be displayed after the reproduction of moving picture information was completed.

As described above, since the apparatus for receiving the digital broadcasting and the apparatus for reproducing the recording medium in which broadcasting service information are recorded are integrally formed as one body, the user may obtain information, which cannot be obtained only by the broadcasting, on the screen, thereby making the apparatus become easier to handle.

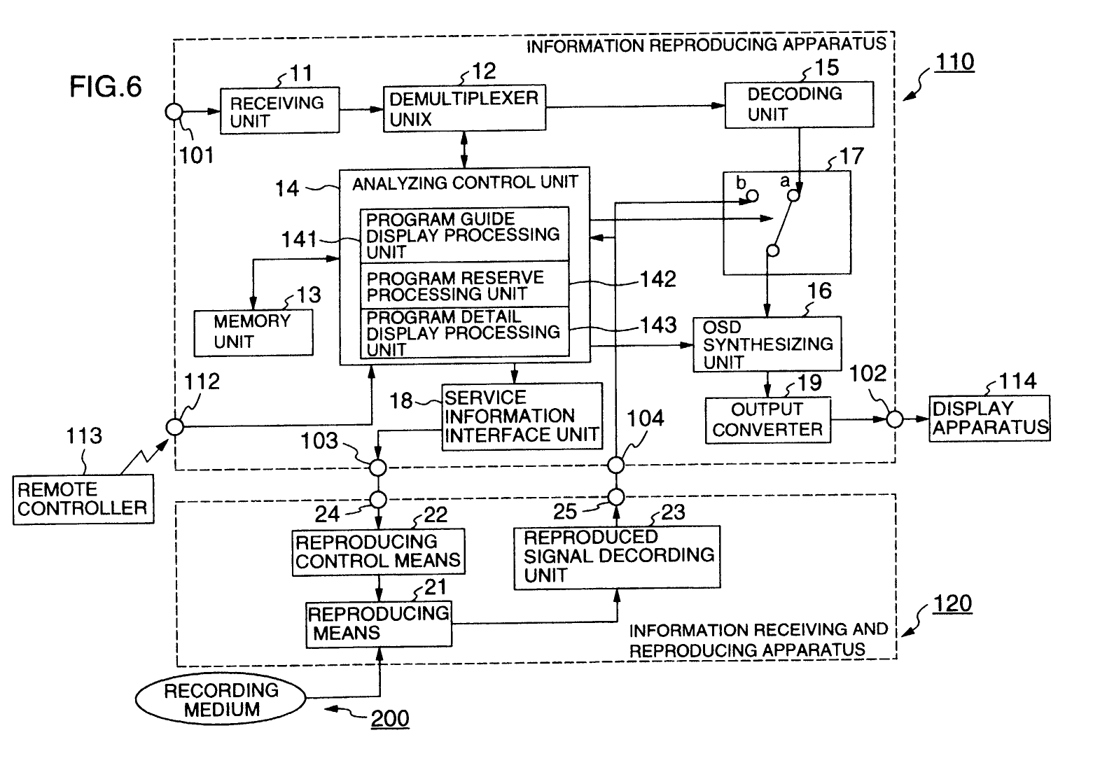

Another embodiment of the present invention will be described below with reference to the drawings. FIG. 6 is a block diagram showing an information receiving and reproducing apparatus according to the second embodiment of the present invention.

In this embodiment, it is to be noted that the information receiving and reproducing apparatus consists of an information receiving apparatus 110 and an information reproducing apparatus 120. In FIG. 6, elements and parts identical to those of the information receiving and reproducing apparatus 100 shown in FIG. 2 are marked with same reference numerals.

As shown in FIG. 6, the information receiving apparatus 110 includes, in addition to the arrangement of the reception processing unit of the information receiving and reproducing apparatus 100 shown in FIG. 2, a control signal output terminal 103, a reproduced signal input terminal 104 and a service information interface unit 18 for controlling the reception and transmission of information between the analyzing control unit 14 and a reproducing control unit 22 disposed in the information reproducing apparatus 120.

As shown in FIG. 6, the signal selecting means 17 is connected behind the decoding unit 15, and selects one of the input terminal a for the decoded received signal from the decoding unit 15 and the input terminal b for the decoded reproduced signal from the reproduced signal decoding unit 23.

As shown in FIG. 6, the information reproducing apparatus 120 includes, in addition to the arrangement of the reproducing processing unit of the information receiving and reproducing apparatus 100 shown in FIG. 2, a control signal input terminal 24, a reproduced signal output terminal 25 and the reproduced signal decoding unit 23 for decoding the encoded signal recorded on the recording medium 200.

An operation of this embodiment will be described below. The second embodiment differs from the first embodiment shown in FIG. 2 in that the information receiving and reproducing apparatus comprises the information receiving apparatus 110 and the information reproducing apparatus 120 wherein a signal between the analyzing control unit 14 and the reproducing control unit 22 is supplied via the service information interface unit 18, the control signal output terminal 103 and the control signal input terminal 24, the decoded signal is inputted to the signal selecting means 17 and that moving picture data recorded on the recording medium 200 is decoded by the reproduced signal decoding unit 23 disposed within the information reproducing apparatus 120 and inputted to the signal selecting means 17 through the reproduced signal output terminal 25 and the reproduced signal input terminal 104. A rest of the second embodiment is the same as that of the first embodiment.

An operation of the second embodiment will be described below with reference to the above-mentioned points different from those of the first embodiment.

When information recorded on the recording medium 200 is reproduced, the service information interface unit 18 converts the control signal from the analyzing control unit 14 into the control signal of the reproduced control unit 22 and outputs the thus converted control signal to the control signal output terminal. The signal outputted from the control signal output terminal 103 is inputted to the control signal input terminal 24.

The reproducing control unit 22 controls the reproducing means 21 in accordance with the control signal inputted from the control signal input terminal 24 in such a manner that the reproducing means 21 reproduces the information from the recording medium 200. The analyzing control unit 14 stores the reproduced program guide information 201 or the like in the memory unit 13.

When moving picture data is reproduced, under control of the analyzing control unit 14, the reproduced signal decoding unit 23 decodes moving picture data of the program moving picture information, and the signal selecting means 17 selects the decoded reproduced signal from the reproduced signal decoding unit 23. The reproduced signal decoding unit 23 decodes moving picture data in the program moving picture information 203 reproduced by the reproducing means 21, and outputs the thus decoded moving picture data to the reproduced signal output terminal 25. The decoded moving picture data signal outputted from the reproduced signal output terminal 25 is inputted through the reproduced signal input terminal 104 to the signal selecting means 17.

An operation in which OSD data is generated, synthesized to the video signal and then outputted is similar to that of the first embodiment.

As described above, since the apparatus for receiving the digital broadcasting and the apparatus for reproducing the recording medium in which service information are recorded are used, the user may obtain information, which cannot be obtained from the received service information only, on the display apparatus, thereby making the information receiving and reproducing apparatus become easier for the user to handle.

As described above, according to the present invention, since there are used the recording medium (e.g. DVD) in which there are recorded service information containing moving picture information comprised of promotion video/audio data of respective programs of broadcasting of one month, for example, and the information receiving and reproducing apparatus for analyzing received or recorded information to control respective units, the user may obtain information, which cannot be obtained from received service information only, on the display apparatus. Furthermore, since service information of one month, for example, may be obtained, it becomes possible to reserve programs within one month. Thus, the information receiving and reproducing apparatus according to the present invention becomes easier for the user to handle.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. An information receiving and reproducing apparatus comprising:
input control apparatus for commanding the selection of desired signal or information data to be displayed;
receiving apparatus for receiving an encoded/multiplexed transmission signal to separate and extract a desired first signal or desired first information data from said received transmission signal under control of said input control apparatus;
reproducing units for reproducing a desired second signal or desired second information data from information recorded on a detachable recording medium under control of said input control apparatus;
selecting means for selecting one of said first signal separated and extracted by said receiving apparatus and said second signal reproduced by said reproducing units under control of said input control apparatus;
a decoding unit for decoding said first or second signal selected by said selecting means;
OSD generating means for generating OSD data based on said first information data separated and extracted by said receiving apparatus or said second information data reproduced by said reproducing units;
an OSD synthesizing unit for synthesizing said OSD data from said OSD generating means to a decoded signal from said decoding unit; and
output means for outputting a signal from said OSD synthesizing unit to a display apparatus.

2. An information receiving and reproducing apparatus as claimed in claim 1, wherein said input control apparatus includes input control apparatus includes input apparatus for commanding the selection of desired signal or information data to be displayed and a control unit for controlling said receiving apparatus, said reproducing units and said selecting means based on commands from said input apparatus.

3. An information receiving and reproducing apparatus as claimed in claim 1, wherein said receiving apparatus is a packet demultiplex apparatus.

4. An information receiving and reproducing apparatus as claimed in claim 3, wherein said transmission signal is a modulated signal and said information receiving and reproducing apparatus includes a receiving unit for demodulating said modulated signal to provide an encoded/multiplexed signal.

5. An information receiving and reproducing apparatus as claimed in claim 1, wherein said second signal is moving picture information.

6. An information receiving and reproducing apparatus as claimed in claim 1, wherein said first and second information data are service information data.

7. An information receiving and reproducing apparatus as claimed in claim 6, wherein said service information data includes a program guide in which programs are displayed for every channel and in the sequential order of time and program detail information indicative of contents of each program.

8. An information receiving and reproducing apparatus as claimed in claim 7, wherein said OSD generating means generates said OSD data containing said program guide displayed on said display apparatus and at least one of a reserve key used to reserve a desired program designated when said desired program is designated from said program guide and a content key for displaying said program detail information corresponding to said desired program based on said first or second information data.

9. An information receiving and reproducing apparatus according to claim 8, further comprising means for reserving said designated program when said reserve key is selected by said input control apparatus.

10. An information receiving and reproducing apparatus according to claim 8, further comprising means for displaying contents of said designated program on said display apparatus based on said program detail information when said content key is selected by said input control apparatus.

11. An information receiving and reproducing apparatus according to claim 1, further comprising a memory unit for memorizing said first information data from said receiving apparatus and said second information data from said reproducing unit and wherein said OSD generating means generates said OSD data based on information data memorized in said memory unit.

12. An information receiving and reproducing apparatus according to claim 1, wherein said output means includes an output converter for converting a signal from said OSD synthesizing unit into a signal suitable for said display apparatus.

13. An information receiving and reproducing apparatus comprising:
input control apparatus for commanding the selection of desired signal or information data to be displayed;
receiving apparatus for receiving an encoded/multiplexed transmission signal to separate and extract a desired first signal or desired first information data from said received transmission signal under control of said input control apparatus;
a first decoding unit for decoding a first signal from said receiving apparatus;
reproducing units for reproducing a desired second signal or desired second information data from information recorded on a detachable recording medium under control of said input control apparatus;
a second decoding unit for decoding a second signal from said reproducing units;
selecting means for selecting one of said first signal decoded by said first decoding unit and said second signal decoded by said second decoding unit under control of said input control apparatus;
OSD generating means for generating OSD data based on said first information data separated and extracted by said receiving apparatus or said second information data reproduced by said reproducing units;
an OSD synthesizing unit for synthesizing said OSD data from said OSD generating means to a selected signal from said selecting means; and
display apparatus for outputting a signal from said OSD synthesizing unit to a display apparatus.

14. A recording medium which can be read out by a computer and wherein there are recorded:
date data within a predetermined time period;
program guide data in which respective programs are recorded for every channel in the sequential order of time at every date of said date data;
program detail data indicating contents corresponding to respective programs in said program guide data; and
program relating data indicating for relating storage places of said respective programs and said program detail data in order to define a corresponding relationship between respective programs in said program guide data and said program detail data.

15. A recording medium as claimed in claim 14, wherein said program detail data includes:
program detail text data indicating contents corresponding to programs in said program guide data; and
program detail moving picture data indicating contents corresponding to respective programs in said program guide data.

16. A recording medium as claimed in claim 15, wherein said program relating data relates storage places of said program detail text data and said program detail moving picture data to respective programs of said program guide data.
